(19) United States
(12) Patent Application Publication
(10) Pub. No.: US 2026/0037605 A1
(43) Pub. Date: Feb. 5, 2026

(54) System and Method of Contextually Authenticating Transactions in Real-Time

(71) Applicant: Next Level3 Software Inc, Hampstead, NC (US)

(72) Inventors: Steven Sholtis, Hampstead, NC (US); Kai Caraganis, Durham, NC (US); William Michael Hudson, JR., Hampstead, NC (US); David Hazar, Draper, UT (US); Latesh Dulani, Orlando, FL (US); Gil Rodriguez, Windermere, FL (US)

(21) Appl. No.: 19/067,586

(22) Filed: Feb. 28, 2025

Related U.S. Application Data
(60) Provisional application No. 63/678,428, filed on Aug. 1, 2024.

(51) Int. Cl. G06F 21/31

(52) U.S. Cl. CPC G06F 21/31

(57) ABSTRACT

A method for providing users with a time-based and approval-based role activation for online transactions, to mitigate the risks of excessive, unnecessary, or misused access permissions on resources, is disclosed. More specifically, the method is a revolutionary, highly secure solution tailored to provide an impenetrable shield for AWS (Amazon Web Services) cloud computing environment against unauthorized intrusion and potential security breaches with a system that incorporates identity verification protocols, multi-factor authentication, and dynamic access controls. Accordingly, the method enables easy registration of a company, securing applications, setting up end users, providing endpoint protection, integrating identity providers, integrating native languages, creating, managing and monitoring JIT policies and activity logs, and enabling and executing JIT approvals for the company's transactions.

The current application claims a priority to the U.S. provisional patent application Ser. No. 63/678,428 filed on Aug. 1, 2024.

### FIELD OF THE INVENTION

The present invention generally relates to a secure authentication and approval system that works against unauthorized intrusion and potential security breaches. More specifically, the present invention is a system that incorporates identity verification protocols, multi-factor authentication, and dynamic access controls through passkeys while authenticating an online transaction.

### BACKGROUND OF THE INVENTION

Security breaches and unauthorized intrusions are common threats of modern-day cyber transactions. A “cloud security breach” refers to a situation where unauthorized individuals gain access to sensitive data stored on a cloud computing platform, essentially meaning someone has broken into a cloud system and accessed private information that they shouldn't have access to, potentially leading to data theft or system disruption; this can happen through various means like misconfigurations, weak passwords, exploited vulnerabilities, or malicious insider actions.

An objective of the present invention is to provide users with a time-based and approval-based role activation for online transactions through passkeys, to mitigate the risks of excessive, unnecessary, or misused access permissions on resources.

### SUMMARY OF THE INVENTION

The present invention is a method of contextually authenticating transactions in real-time, wherein passkeys are used to confirm a user's identity at multiple time points during the flow of an online transaction. More specifically, the present invention uses passkeys to validate someone's identity, not just at authentication time, but for literally any action that a user can perform in an application. The actions that a company or client wants to trigger confirmation of a user's identity on are defined in the present invention using JIT (just-in-time) approval templates. These templates allow the company (client) to specify what information is sent to the user while passkey validation occurs as well as who else must also review and approve the actions before the original action triggered in the application can be performed.

More specifically, JIT approvals approve an action in a program. To get that approval, a customized notification is sent to one or more approvers that includes information about the action, transaction, and any additional context required for the approvers to use in deciding to approve the action. To approve the action, the approvers must each validate their identity using a passkey prior to being able to approve the action(s). There are a number of use cases in which JIT Approvals provide solutions to solve problems. This document will outline each of the JIT Approval types available to you and will define how to create, use, and manage the present invention's JIT Approvals within your Company Portal.

### BRIEF DESCRIPTION OF THE DRAWINGS

FIG. 1 is a block diagram illustrating the system of the present invention.

FIG. 2 is a flowchart illustrating an overall process for the method of the present invention.

FIG. 3 is a flowchart illustrating a subprocess for completing an online application.

FIG. 4 is a flowchart illustrating a subprocess for validating a domain.

FIG. 5 is a flowchart illustrating a subprocess for managing access to end users.

FIG. 6 is a flowchart illustrating a subprocess for verifying a user through an authentication token.

FIG. 7 is a flowchart illustrating a subprocess for selecting at least one JIT policy by the client from a list of already available policies.

FIG. 8 is a flowchart illustrating a subprocess for editing the selected policy by the client.

FIG. 9 is a flowchart illustrating a subprocess for creating a customized policy with the help of portal provided guidelines.

FIG. 10 is a flowchart illustrating a subprocess for editing a customized policy at any stage by the client.

FIG. 11 is a flowchart illustrating a subprocess for actuating the authentication process for the specific transaction.

FIG. 12 is a flowchart illustrating a subprocess for providing a JIT approval by a default approver.

FIG. 13 is a flowchart illustrating a subprocess for providing a JIT approval through a signature.

FIG. 14 is a flowchart illustrating a subprocess for confirming a GPS location as part of the authentication template.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is it to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one” but does not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

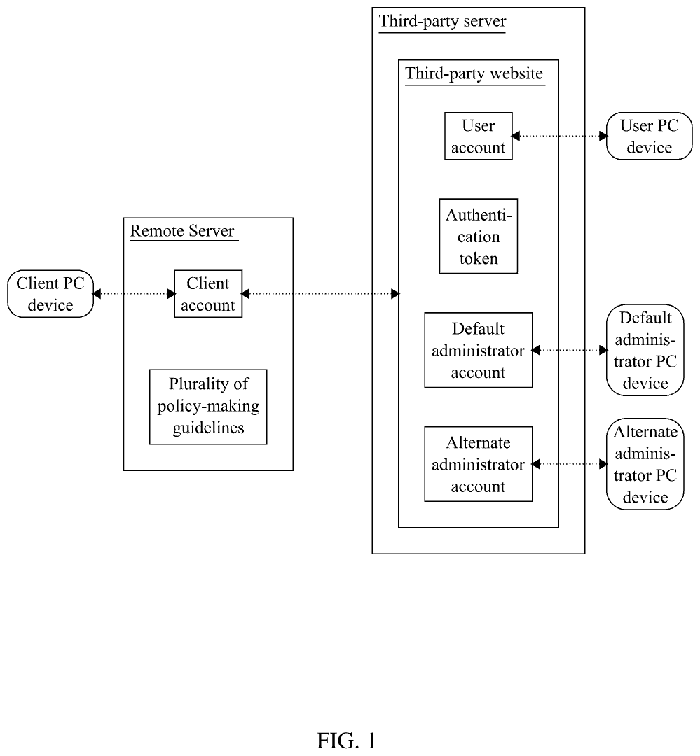

In reference to FIG. 1 through FIG. 14, the present invention is a system and method of contextually authenticating and/or validating online transactions in real-time. In order to accomplish the above-described functionality, the system used to execute the method of the present invention begins by providing at least one client account managed by at least one remote server (Step A). Further, the client account is associated with a corresponding client personal computing (PC) device. Preferably, the client account is the account of the company user, who is using the present invention through the corresponding client personal PC device. For example, if the company is a bank, named Bank A, and Bank A is availing the cyber protection for the bank's applications and/or transactions through the present invention, then the at least one client account belongs to the bank manager, who is accessing the present invention through the corresponding client PC device. The corresponding PC devices used to interact with the present invention can be, but is not limited to, a smartphone, a laptop, a desktop, or a tablet PC. The remote server is used to execute most steps for the method of the present invention and is used as a hub to manage and exchange information. Moreover, the remote server is used to execute a number of internal processes for the present invention and is used to store user information.

Continuing on, the system used to execute the method of the present invention further provides at least one third-party website hosted by at least one third-party server (Step B). Preferably, the at least one user account for the third-party website is managed by the third-party server, and the user account is associated with a corresponding user PC device. Preferably, the at least one third-party website is the company's website that is using services provided by the present invention. For example, the at least one third-party website maybe the banking website for Bank A, and the at least one user account belongs to the end user of Bank A, that has money in Bank A and can access their bank account details through the third-party website.

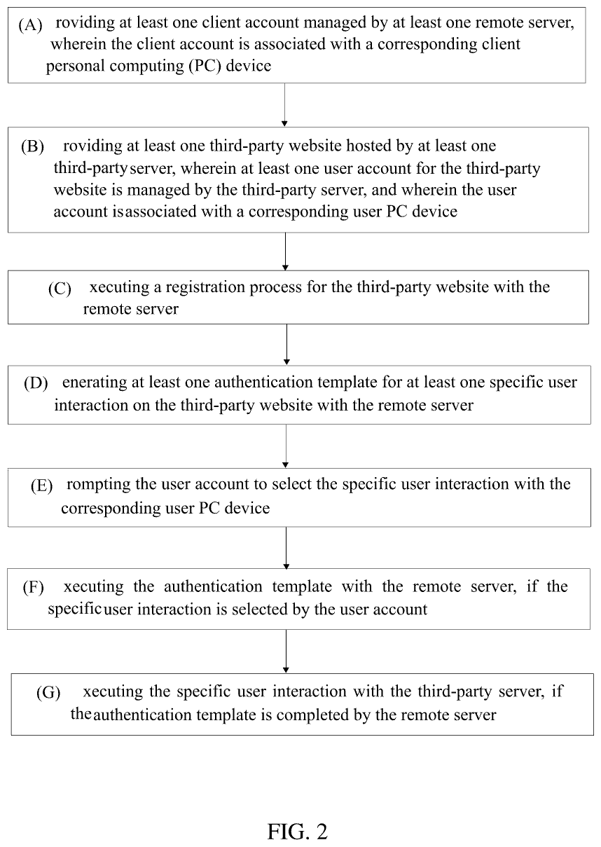

As can be seen in FIG. 2, now that the system used to execute the method of the present invention has been described, it is possible to adequately describe an overall process for the method of the present invention. The overall process begins by executing a registration process for the third-party website with the remote server (Step C). The registration process is a process of entering Customer's details on Company's website or through its mobile application registration process, which once completed will be regarded as an agreement entered into between Company and Customer into which these Terms are incorporated as an attachment or will be available online through a link. Accordingly, in terms of starting to protect a user's applications and identity today, the first step in setting up the user's company portal is to register the user's company. This allows to secure their applications, set up identity provider integrations, manage clients and groups, view access activity, create cyber policies, use native language integrations, and implement pluggable authentication modules. Further, the present invention is available for both Android and iOS devices and is available on both the Apple and Google Play Stores. To access the company portal on a user's mobile device, the registration process may start by getting the application. The overall process continues by generating at least one approval template for at least one specific user interaction on the third-party website with the remote server (Step D). The at least one specific user interaction is any online action related to the user's company, that warrant a confirmation of an end user's identity, an approval, or review from one or more members of the user's company, etc. Examples of the at least one specific user interaction include, but are not limited to, an online purchase of office supplies, online banking transactions, initiating a new hire in a company, purchase tickets, etc. This is so that the company's applications are securely transferred and made available for use through a portal of the present invention. The approval templates allow companies to define what contextually relevant information must be shown to a user when an action that they are performing requires approval from one or more approvers. An approval template allows companies to optionally define approvers as default approvers. The values passed, approvers and contextually relevant information can however be overridden at the time that an approval is generated. Approvals are sent to users who must authenticate and unlock access to a passkey used to approve approvals. In order to view/approve/reject an approval, the approvers must each validate their approval passkey. The authentication process used to unlock the passkey required for approvals can also use passkey technologies, biometrics, and other secure authentication mechanisms. The authentication process is a dynamic approval process which allows actions in applications to be secured using passkey validation prior to execution in much the same way as passkeys are used today to validate a user's identity, users are using passkeys to confirm an approval of an action in a flow using contextually relevant information.

Moreover, the overall process continues by prompting the user account to select the specific user interaction with the corresponding user PC device (Step E). Like most companies, there is more than one user identity that has access to its applications and a security requirement to protect its users' identities. The present invention allows the client account to allocate access privileges to provide multiple layers of security to the users and groups in the company's network and create or remove these access privileges as needed by selecting or creating specific approval templates suited for their company through the present invention. The overall process continues by executing the approval template with the remote server, if the specific user interaction is selected by the user account (Step F). The overall process concludes by executing the specific user interaction with the third-party server, if the approval template is completed by the remote server (Step G). An approval template includes a dynamic approval process which allows actions in applications to be secured using passkey validation prior to execution in much the same way as passkeys are used today to validate a user's identity. In other words, users are using passkeys to confirm an approval of an action in a flow using contextually relevant information. There are a number of use cases in which JIT Approvals provide solutions to solve problems. In other words, the present invention provides time-based and approval-based role activation to mitigate the risks of excessive, unnecessary, or misused access permissions on resources.

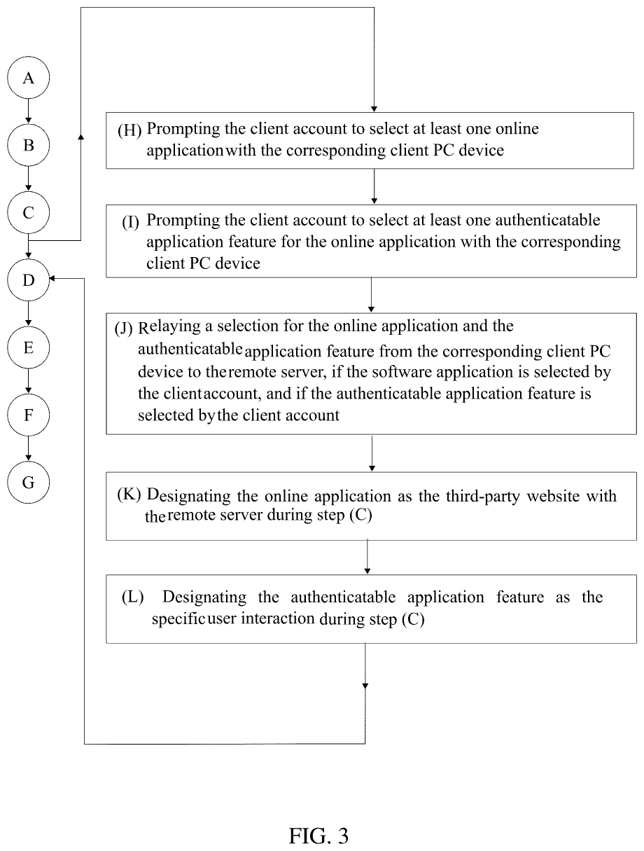

In reference to FIG. 3, a preferred method of the present invention implements a subprocess for implementing the registration process during Step C. This subprocess begins by prompting the client account to select at least one online application with the corresponding client PC device (Step H). The at least one online application are programs that companies use to perform tasks and manage different aspects of their operations. These programs help businesses work more effectively, make better decisions, and better serve customers. More specifically, the present invention allows a client account to add their company applications to the portal, which will then require a Zero Trust-oriented Multifactor Authentication to access them. Once an online application is added, the client account can enable or disable account access to the online application and monitor access activity. Further, this subprocess continues by prompting the client account to select at least one authenticatable application feature for the online application with the corresponding client PC device (Step I). The at least one authenticatable application feature is part of a process or the online application, that may be validated through the method of the present invention. More specifically, the actions that the client account want to trigger confirmation of a user's identity, approval, or review on, are defined in the present invention's method, which allows client accounts to specify what information is sent to the end user while passkey validation occurs, as well as who else must also review and approve the actions before the original action triggered in the application can be performed. Thus, this subprocess continues by relaying a selection for the online application and the authenticatable application feature from the corresponding client PC device to the remote server, if the software application is selected by the client account, and if the authenticatable application feature is selected by the client account (Step J). In other words, the client account selects a set of authenticatable application features from the third-party website (e.g., banking website) and uploads them to the present invention's portal. Finally, this subprocess concludes by designating the online application as the third-party website with the remote server during Step C (Step K), followed by designating the authenticatable application feature as the specific user interaction during Step C (Step L). Thus, during the registration process, the present invention allows client accounts to upload their applications, as well as select specific actions, and features of the online applications, to the present invention's portal.

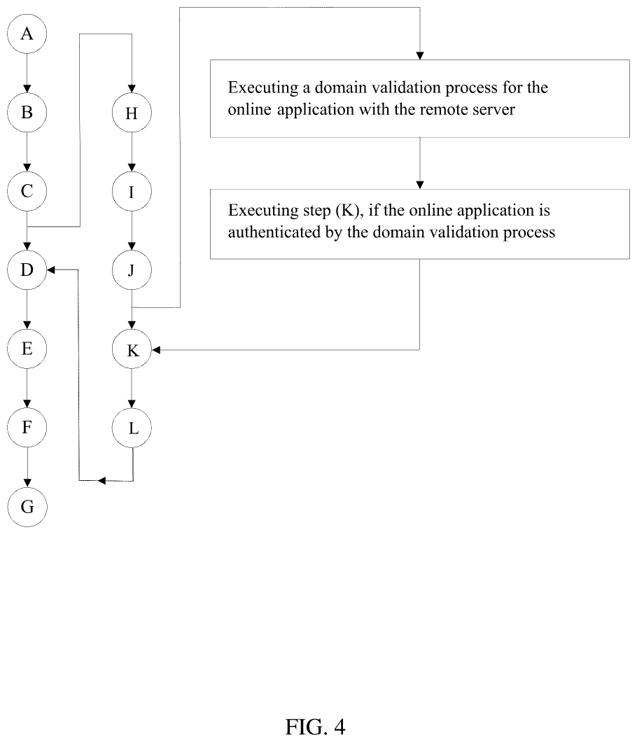

In reference to FIG. 4, the preferred method of the present invention implements a subprocess for executing a domain validation as part of the registration process. Accordingly, the subprocess comprises executing a domain validation process for the online application with the remote server, followed by executing Step K, if the online application is authenticated by the domain validation process. For example, the domain validation process requires domain validation from an authoritative DNS (domain name system) server using a CNAME (Canonical Name) which will generate a sign in key that will be used to sign the JSON (JavaScript Object Notation) web tokens that are required to check lock statuses for users.

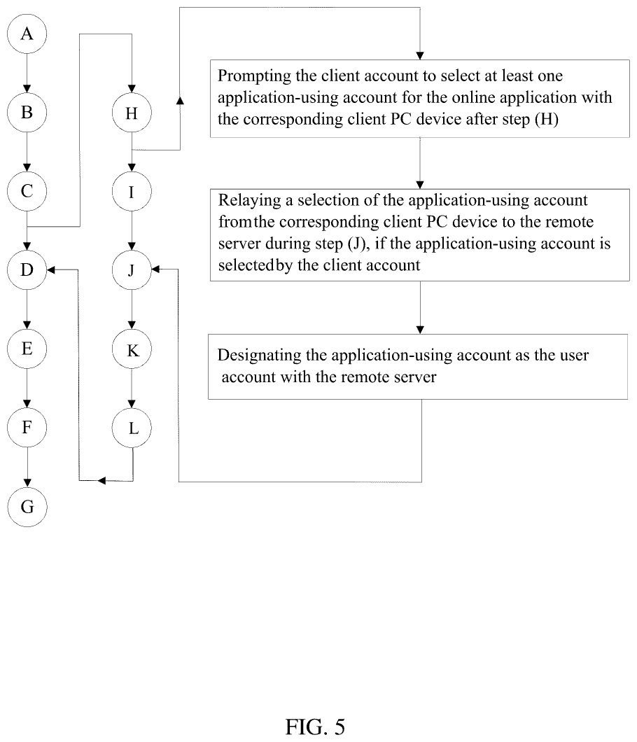

In reference to FIG. 5, the method of the present invention may implement a subprocess for providing and managing access to end users for using the online application by the client account. In order to view and monitor access for company applications, the company or client account needs to configure your users and groups for application access. Accordingly, this subprocess begins by prompting the client account to select at least one application-using account for the online application with the corresponding client PC device after Step H. The application-using account is the end user who has preciously registered with the company's site (e.g., Bank A's website) and in doing so set up a passkey for identity verification with the present invention's system. Further, this subprocess continues by relaying a selection of the application-using account from the corresponding client PC device to the remote server during Step J, if the application-using account is selected by the client account. In other words, the company or client account can see and select from end users and groups that can have access to their company's online applications. Thus, this subprocess concludes by designating the application-using account as the user account with the remote server. In the preferred embodiment, there are two methods for adding users to the company portal; the opt-in method and automatic enrollment method. The client account may choose one of the two methods for adding end users or application-using accounts. Furthermore, the company can add users manually, and/or create and edit groups through the corresponding client PC device.

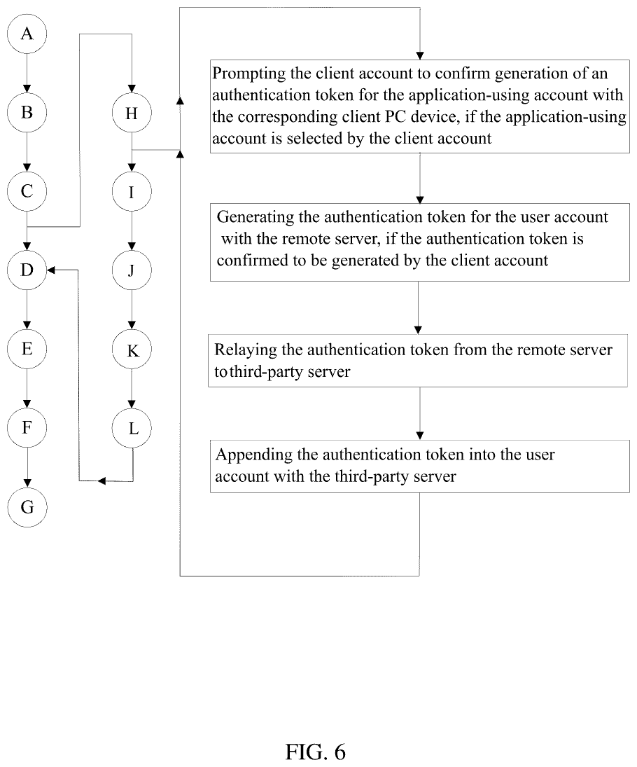

In reference to FIG. 6, the method of the present invention may implement a subprocess for enabling user verification through an authentication token. An authentication token can be used to verify user identity. Once the authentication token has been verified, the user receives an Access Token which grants the user access to a service that the Access Token has been issued for and works until the Access Token becomes invalid. Accordingly, this subprocess begins by prompting the client account to confirm generation of an authentication token for the application-using account with the corresponding client PC device, if the application-using account is selected by the client account. This subprocess continues by generating the authentication token for the user account with the remote server, if the authentication token is confirmed to be generated by the client account. Further, this subprocess continues by relaying the authentication token from the remote server to third-party server. Furthermore, this subprocess continues by appending the authentication token into the user account with the third-party server. Thus, the authentication token is assigned to the end user. In other words, JIT Approval Authentication of the present invention uses this subprocess to grant elevated privileges to the end users for the company's applications and supports protecting the company's applications by integrating Cloud Identity JIT Approvals directly to the company's applications. Generating the Authentication token required to make calls for the company's application depends on the language the company's application uses.

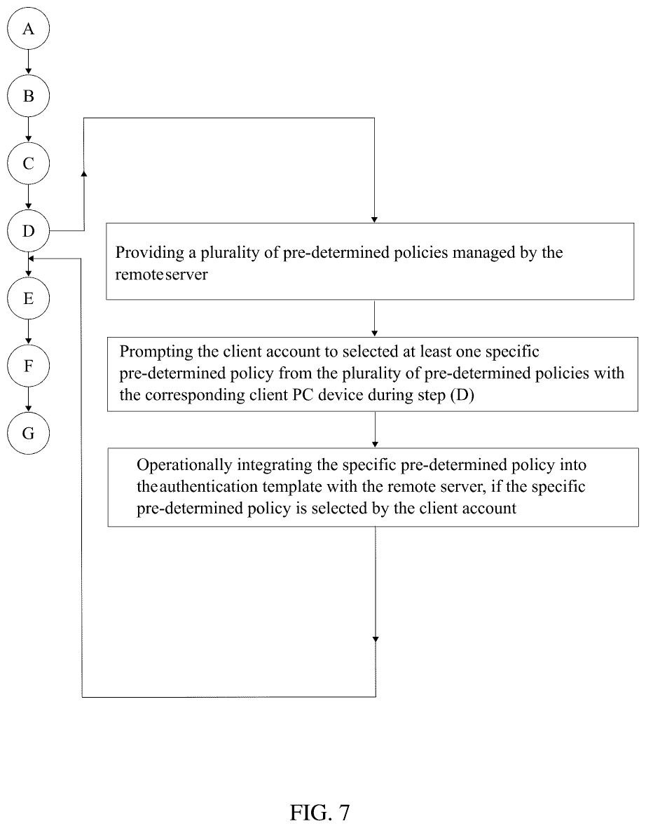

In reference to FIG. 7, the method of the present invention may implement a subprocess for selecting at least one JIT policy or real-time authentication policy by the client from a list of already available policies. Accordingly, this subprocess begins by providing a plurality of pre-determined policies managed by the remote server. The plurality of pre-determined policies or JIT Policies are used to control access to application accounts and manage that access for company's end users (e.g., employees, contractors, third parties and customers). There are a number of use cases for a variety of industries in which Cyber Policies provide solutions to solve problems. Some examples of the plurality of pre-determined policies provided by the present invention are as follows:
Scheduled Policies—Policies triggered at a scheduled time.
Multi-Approval Policies—Policies requiring more than one user to approve unlocking an account prior to account unlock.
Alert Policies—Policies that are triggered when an alert occurs from an external system such as an EDR, IDR, SIEM tools, or other alert everting system.

This subprocess continues by prompting the client account to select at least one specific pre-determined policy from the plurality of pre-determined policies with the corresponding client PC device during Step D. For example, the client account may select a Scheduled policy to lock and unlock accounts at a specific time. Further, the subprocess continues by operationally integrating the specific pre-determined policy into the approval template with the remote server, if the specific pre-determined policy is selected by the client account. For example, an online application of the company may be scheduled to run starting on a specific date and can optionally have an end date.

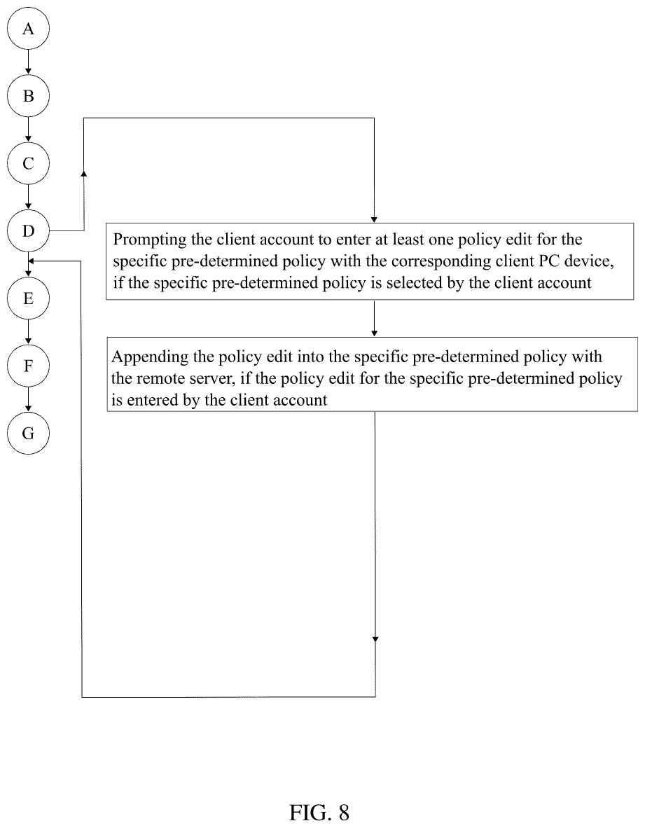

In reference to FIG. 8, the method of the present invention may implement a subprocess for editing an already existing policy by the client account to suit the company's needs. Accordingly, this subprocess begins by prompting the client account to enter at least one policy edit for the specific pre-determined policy with the corresponding client PC device, if the specific pre-determined policy is selected by the client account. For example, the at least one policy edit maybe the start date, end date, how many approvals are needed, etc. Further, this subprocess concludes by appending the policy edit into the specific pre-determined policy with the remote server, if the policy edit for the specific pre-determined policy is entered by the client account. This helps each company to have a customized policy that matches the company's requirements as well as have access to control and manage their applications accordingly.

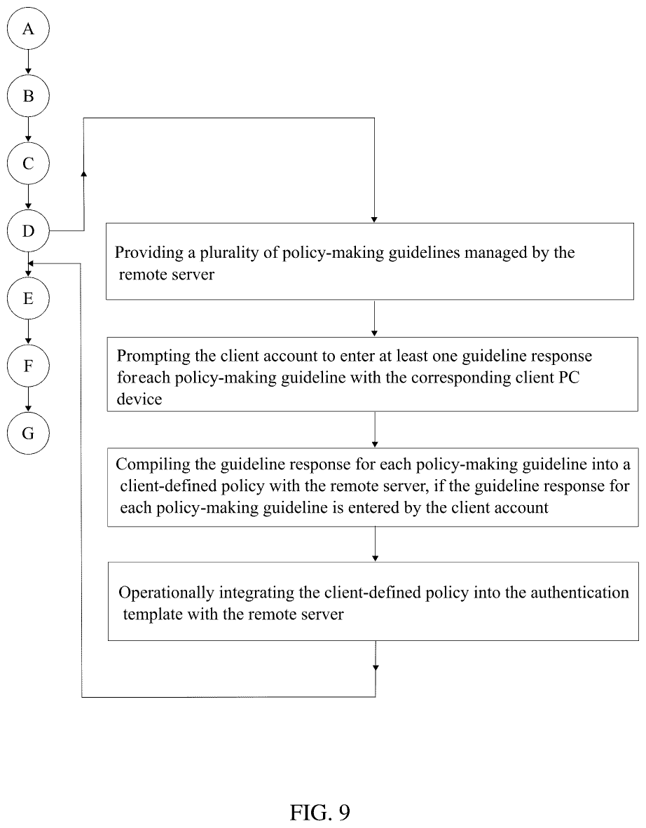

In reference to FIG. 9, the method of the present invention may implement a subprocess for creating a customized policy by the client account. In other words, this subprocess enables the client account to create a new policy and allows the client account to specify various parameters of the new policy. Accordingly, this subprocess begins by providing a plurality of policy-making guidelines managed by the remote server. This subprocess continues by prompting the client account to enter at least one guideline response for each policy-making guideline with the corresponding client PC device. Examples of at least one guideline response includes, but are not limited to policy type, policy name, start-date, end-date, etc. Further, this subprocess continues by compiling the guideline response for each policy-making guideline into a client-defined policy with the remote server, if the guideline response for each policy-making guideline is entered by the client account. In other words, companies or client accounts are able to create their own client-defined policy, that matches with the companies' needs. Subsequently, this subprocess continues by operationally integrating the client-defined policy into the approval template with the remote server. Thus, the present invention provides customizable cyber security solutions to different companies by providing control access to application accounts and managing that access for the company's users (employees, contractors, third parties and customers).

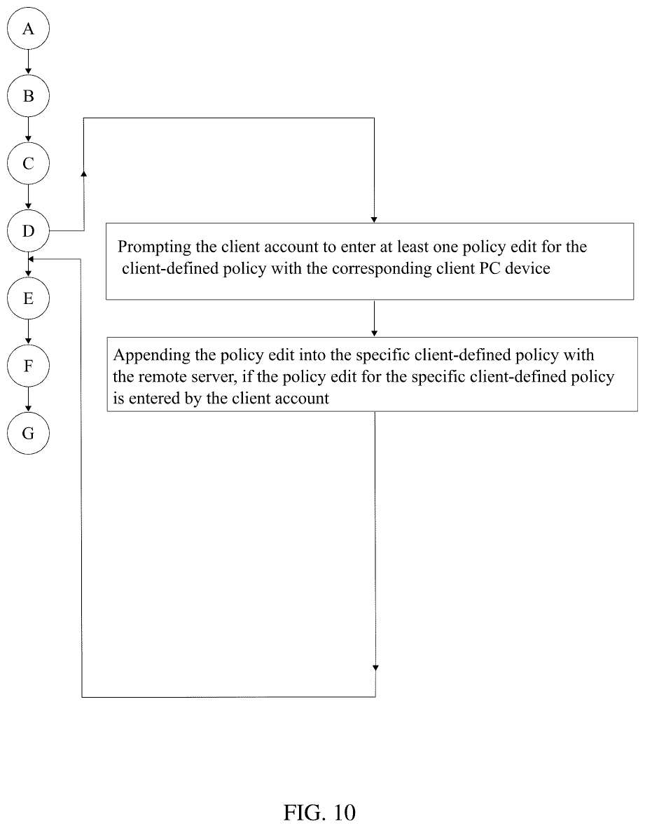

In reference to FIG. 10, the preferred method of the present invention implements a subprocess that allows the client account to edit a customized policy during any stage, if needed. Accordingly, this subprocess begins by prompting the client account to enter at least one policy edit for the client-defined policy with the corresponding client PC device. Further, this subprocess continues by appending the policy edit into the specific client-defined policy with the remote server, if the policy edit for the specific client-defined policy is entered by the client account.

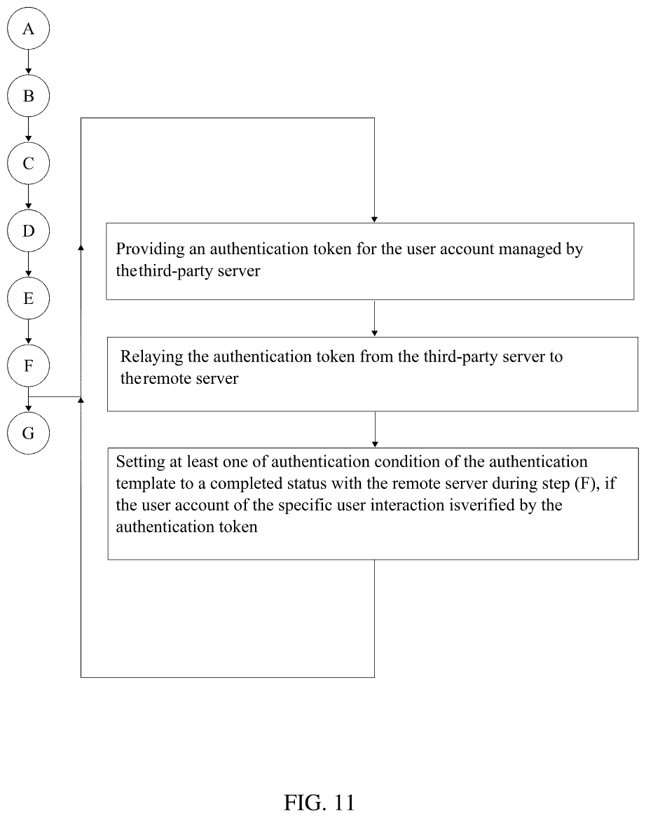

According to the present invention, JIT approvals are used to grant elevated privileges to your users for your applications. As earlier described in the subprocess in FIG. 6, once the user is verified through the authentication token, the authentication process for the specific user interaction is actuated. In reference to FIG. 11, the method of the present invention may implement a subprocess for executing an authentication process. Accordingly, this subprocess begins by providing an authentication token for the user account managed by the third-party server and by then relaying the authentication token from the third-party server to the remote server. Further, this subprocess concludes by setting the at least one of authentication condition of the approval template to a completed status with the remote server during Step F, if the user account of the specific user interaction is verified by the authentication token.

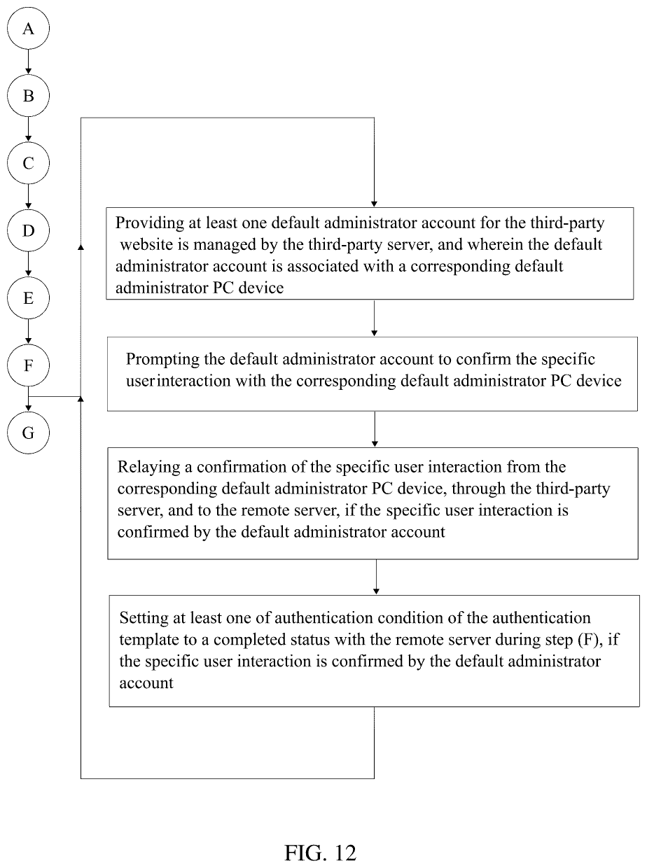

Continuing with the preferred embodiment, the JIT approval process requires an administrator's approval, that when approved will provide access to the user in real time. In reference to FIG. 12, the method of the present invention may implement a subprocess for JIT approval by an administrator account. Accordingly, this subprocess begins by providing at least one default administrator account for the third-party website managed by the third-party server, wherein the default administrator account is associated with a corresponding default administrator PC device. The default administrator account is defined as one of the authenticatable application features (who must also review and approve the actions before the original action triggered in the application) for the online application uploaded, through the approval template. Further, this subprocess continues by prompting the default administrator account to confirm the specific user interaction with the corresponding default administrator PC device. That is, confirmation from the default administrator account is requested to proceed with executing the application. Subsequently, this subprocess continues by relaying confirmation of the specific user interaction from the corresponding default administrator PC device, through the third-party server, and to the remote server, if the specific user interaction is confirmed by the default administrator account. For example, an end user (customer of Bank A) can provide identity confirmation (through passkeys) to the default administrator account as a specific user interaction. Furthermore, this subprocess concludes by setting at least one of authentication condition of the approval template to a completed status with the remote server during step (F), if the specific user interaction is confirmed by the default administrator account. In other words, the at least one authentication condition, which is part of the approval template has to be fulfilled through confirmation from the default administrator account, for an online transaction to go through or get completed.

Currently, there are two approval types, according to the present invention.

Approve—JIT access approval request that when triggered requires the default approver to approve the request that they received.

Sign and Approve—JIT access approval request that when triggered required the default approver to sign the request with their signature and then approve the request that is sent.

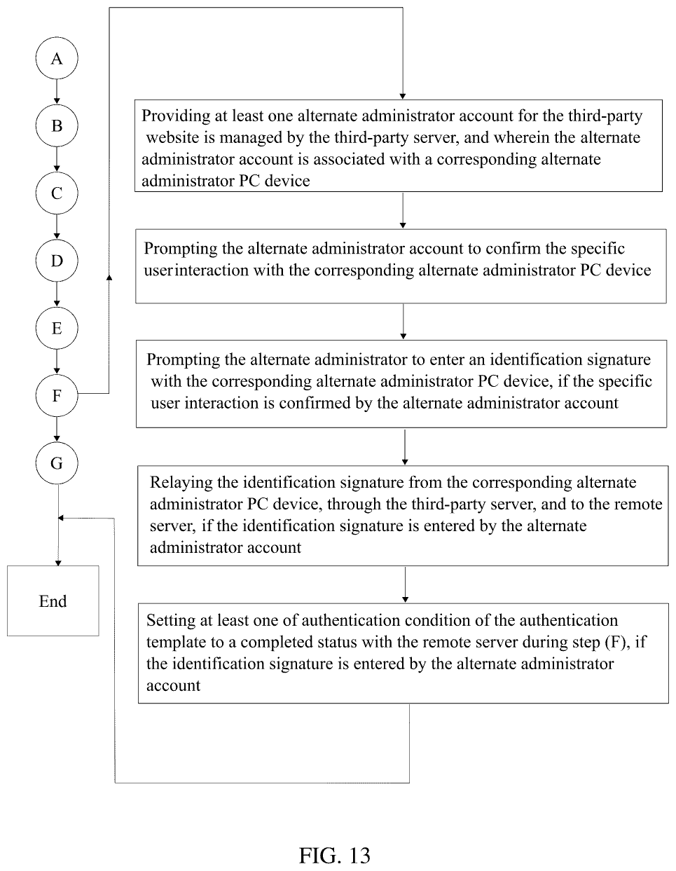

In reference to FIG. 13, the method of the present invention may implement a subprocess for signing off on an approval by a specific authority. Accordingly, this subprocess by providing at least one alternate administrator account for the third-party website is managed by the third-party server, and wherein the alternate administrator account is associated with a corresponding alternate administrator PC device. The alternate administrator is the specific authority, whose signature is required as part of the authentication process. This subprocess continues by prompting the alternate administrator account to confirm the specific user interaction with the corresponding alternate administrator PC device. Further, this subprocess continues by prompting the alternate administrator to enter an identification signature with the corresponding alternate administrator PC device, if the specific user interaction is confirmed by the alternate administrator account. In other words, the identification signature is the signature from a specific official that is integrated as part of the approval template, which adds an additional layer of security. Furthermore, this subprocess continues by relaying the identification signature from the corresponding alternate administrator PC device, through the third-party server, and to the remote server, if the identification signature is entered by the alternate administrator account. For example, an online banking transaction may only get completed after receiving signature from the bank manager (alternate administrator) if that authentication condition is made part of the approval template for that specific user interaction. Finally, this subprocess concludes by setting at least one of authentication condition of the approval template to a completed status with the remote server during Step F, if the identification signature is entered by the alternate administrator account.

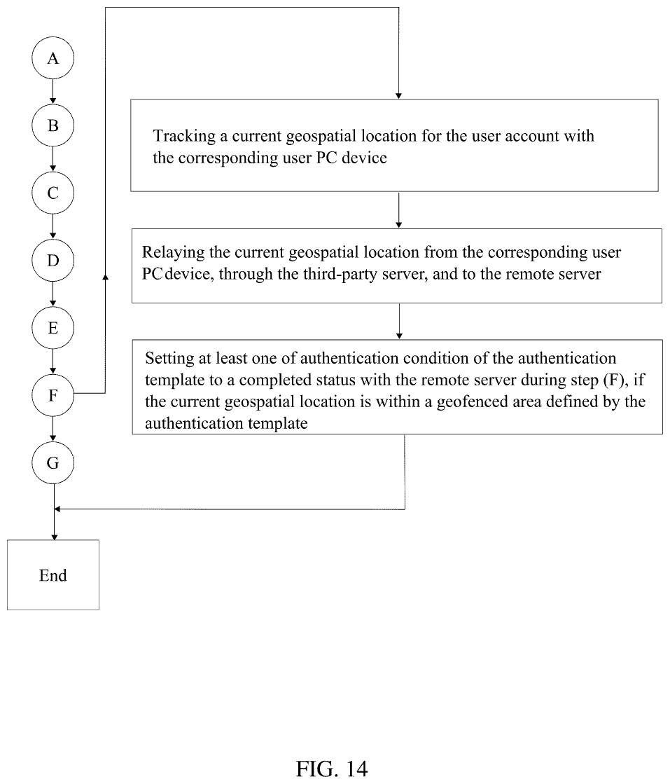

In reference to FIG. 14, the method of the present invention may implement a subprocess for confirming GPS (global positioning system) location of the end-user as an authentication condition in the approval template for a specific transaction. Accordingly, this subprocess begins by tracking the current geospatial location for the user account with the corresponding user PC device. This subprocess continues by relaying the current geospatial location from the corresponding user PC device, through the third-party server, and to the remote server. Further, this subprocess concludes by setting at least one of authentication condition of the approval template to a completed status with the remote server during Step F, if the current geospatial location is within a geofenced area defined by the approval template.

An example scenario with steps for authenticating a transaction using JIT approvals is provided below:
1. Admin defines a template that sends users the following:
   Purchase Amount
   Item
2. Company developer sets up a call to perform a JIT approval whenever a purchase is attempted.
3. End users tried to buy an item. The end user has previously registered with the company's website and in doing so, has set up a passkey for identity verification with the system. This passkey is not used to authenticate the user for determining access but is used for identity confirmation in approving JIT Approval requests.
4. A JIT Approval request is sent to the user using a push notification or other notification method.
   The request contains:
   Purchase Amount—25$
   Item—Socks
5. The user authenticates using biometrics to their passkey storage and uses the passkey to confirm their identity, at which point the company can then approve or deny the action, in this case, buying socks.
6. If anyone else has to approve the action, as defined in the approval template flows, they follow the same process.

Just like the above example, JIT Approvals may be used to confirm any action taken in an application forcing a passkey validation for each user, who is required to confirm their identity action after reviewing any data they are sent in the Approval

Request. All these conditions will be defined in the corresponding approval templates and then hooked into application actions as a precheck on those actions being performed pending passkey validation.

The following is a summary of the overall method according to the preferred embodiment of the present invention with examples of specific applications and services used.

In terms of setting up your account, the first step to get started using the present invention, is to create your account. This can be done by either using your desktop through a web browser or mobile device through the app which is available for Android and iOS devices. To utilize the full capabilities of the present invention's security features you will need to configure your account using a desktop because the mobile application doesn't have access to configuration functionality.

In terms of securing your applications, the present invention's authentication is a Zero-Trust Identity Access Authentication service that is used for securing your company's applications. When implemented, it enables you to set lock statuses for applications, manage the users that have access to them, and monitor access activity.

In terms of setting up end users, like most companies, there is more than one user identity that has access to its applications and a security requirement to protect its users' identities. The present invention's JIT Access allows you to allocate access privileges to provide multiple layers of security to the users and groups in your network and create or remove them as needed. In terms of integrating your identity provider, the present invention's integrations are designed to be used for any of your existing applications or sites which are using Auth0, Microsoft Azure AD B2C, Microsoft Azure AD and O365, AWS Cognito, and AWS IAM for authentication. Integrating your identity provider with Next Level3 will add the extra layer of security needed to secure your organizational identities.

In terms of native language integrations, the present invention's native language integrations include Node JS, Python, and Microsoft .NET Framework. This will allow users to easily add account protection to any application.

In terms of cyber policies and monitoring activity, cyber-Policies are used to control access to your application accounts and manage that access for your companies' users (employees, contractors, third parties and customers). There are a number of use cases for a variety of industries in which Cyber Policies provide solutions to solve problems. With the present invention's activity logs, you can view your company's user activity. This feature allows you to monitor account lock statuses and when a user has accessed your company applications.

In terms of just-in-time (JIT) approvals, JIT approvals approve an action in a program. To get that approval, a customized notification is sent to one or more approvers that includes information about the action, transaction and any additional context required for the approvers to use in deciding to approve the action. To approve the action, the approvers must each validate their identity using a passkey prior to being able to approve the action(s). For example: A user wants to purchase tickets. Prior to this, the ticket selling application setup a custom template defining the details and context which is sent to end users when a ticket purchase transaction is initiated. The user initiates the purchase. The end user is setup as an approver. The user is sent a push notification that contains all the details of the transaction defined in the template. The user authenticates again by unlocking access to their passkey on an approved device. The passkey is validated with the approval system and the transaction is allowed.

For example: A user wants to initiate a new hire. Prior to this the company hosting the employee management system has defined a template which contains the context required for users to approve a new hire. The template defines that the hiring manager and his immediate manager along with an HR representative must approve new hire transactions. The hiring manager receives a notification with the context of the transaction as defined in the approval template ahead of time. The hiring manager approves the hire and another push is sent to the immediate manager, who receives additional context based on the template, and so on until the approvals are approved/rejected. In all of these examples, users are receiving customer approval notifications that contain the required context to approve/reject the transactions. The users to review/approve/reject approval notifications must validate their identity by unlocking access to a passkey specifically used for approvals (not authentication) after validating their identity using biometric authentication.

In terms of application programming interface (API) documentation, the present invention is hosted by Swagger UI. In case you need to reference it, it is available both externally for public access and internally once you have registered your company account.

Although the invention has been explained in relation to its preferred embodiment, it is to be understood that many other possible modifications and variations can be made without departing from the spirit and scope of the invention as hereinafter claimed.

What is claimed is:

1. A method of contextually authenticating a transaction in real-time, the method comprising the steps of:
(A) providing at least one client account managed by at least one remote server, wherein the client account is associated with a corresponding client personal computing (PC) device;
(B) providing at least one third-party website hosted by at least one third-party server, wherein at least one user account for the third-party website is managed by the third-party server, and wherein the user account is associated with a corresponding user PC device;
(C) executing a registration process for the third-party website with the remote server;
(D) generating at least one approval template for at least one specific user interaction on the third-party website with the remote server;
(E) prompting the user account to select the specific user interaction with the corresponding user PC device;
(F) executing the approval template with the remote server, if the specific user interaction is selected by the user account; and
(G) executing the specific user interaction with the third-party server, if the approval template is completed by the remote server.

2. The method as claimed in claim 1 further comprising the steps of:
(H) prompting the client account to select at least one online application with the corresponding client PC device;
(I) prompting the client account to select at least one authenticatable application feature for the online application with the corresponding client PC device;
(J) relaying a selection for the online application and the authenticatable application feature from the corresponding client PC device to the remote server, if the software application is selected by the client account, and if the authenticatable application feature is selected by the client account;
(K) designating the online application as the third-party website with the remote server during step (C); and
(L) designating the authenticatable application feature as the specific user interaction during step (C).

3. The method as claimed in claim 2 further comprising the steps of:
executing a domain validation process for the online application with the remote server; and
executing step (K), if the online application is authenticated by the domain validation process.

4. The method as claimed in claim 2 further comprising the steps of:
prompting the client account to select at least one application-using account for the online application with the corresponding client PC device after step (H);
relaying a selection of the application-using account from the corresponding client PC device to the remote server during step (J), if the application-using account is selected by the client account; and
designating the application-using account as the user account with the remote server.

5. The method as claimed in claim 4 further comprising the steps of:
prompting the client account to confirm generation of an authentication token for the application-using account with the corresponding client PC device, if the application-using account is selected by the client account;
generating the authentication token for the user account with the remote server, if the authentication token is confirmed to be generated by the client account;
relaying the authentication token from the remote server to third-party server; and
appending the authentication token into the user account with the third-party server.

6. The method as claimed in claim 1 further comprising the steps of:
providing a plurality of pre-determined policies managed by the remote server;
prompting the client account to select at least one specific pre-determined policy from the plurality of pre-determined policies with the corresponding client PC device during step (D); and
operationally integrating the specific pre-determined policy into the approval template with the remote server, if the specific pre-determined policy is selected by the client account.

7. The method as claimed in claim 6 further comprising the steps of:
prompting the client account to enter at least one policy edit for the specific pre-determined policy with the corresponding client PC device, if the specific pre-determined policy is selected by the client account; and
appending the policy edit into the specific pre-determined policy with the remote server, if the policy edit for the specific pre-determined policy is entered by the client account.

8. The method as claimed in claim 1 further comprising the steps of:
providing a plurality of policy-making guidelines managed by the remote server;
prompting the client account to enter at least one guideline response for each policy-making guideline with the corresponding client PC device;
compiling the guideline response for each policy-making guideline into a client-defined policy with the remote server, if the guideline response for each policy-making guideline is entered by the client account; and
operationally integrating the client-defined policy into the approval template with the remote server.

9. The method as claimed in claim 8 further comprising the steps of:
prompting the client account to enter at least one policy edit for the client-defined policy with the corresponding client PC device; and
appending the policy edit into the specific client-defined policy with the remote server, if the policy edit for the specific client-defined policy is entered by the client account.

10. The method as claimed in claim 1 further comprising the steps of:
providing an authentication token for the user account managed by the third-party server;
relaying the authentication token from the third-party server to the remote server; and
setting at least one of authentication condition of the approval template to a completed status with the remote server during step (F), if the user account of the specific user interaction is verified by the authentication token.

11. The method as claimed in claim 1 further comprising the steps of:
providing at least one default administrator account for the third-party website is managed by the third-party server, and wherein the default administrator account is associated with a corresponding default administrator PC device;
prompting the default administrator account to confirm the specific user interaction with the corresponding default administrator PC device;
relaying a confirmation of the specific user interaction from the corresponding default administrator PC device, through the third-party server, and to the remote server, if the specific user interaction is confirmed by the default administrator account; and
setting at least one of authentication condition of the approval template to a completed status with the remote server during step (F), if the specific user interaction is confirmed by the default administrator account.

12. The method as claimed in claim 1 further comprising the steps of:
providing at least one alternate administrator account for the third-party website is managed by the third-party server, and wherein the alternate administrator account is associated with a corresponding alternate administrator PC device;
prompting the alternate administrator account to confirm the specific user interaction with the corresponding alternate administrator PC device;
prompting the alternate administrator to enter an identification signature with the corresponding alternate administrator PC device, if the specific user interaction is confirmed by the alternate administrator account;
relaying the identification signature from the corresponding alternate administrator PC device, through the third-party server, and to the remote server, if the identification signature is entered by the alternate administrator account; and
setting at least one of authentication condition of the approval template to a completed status with the remote server during step (F), if the identification signature is entered by the alternate administrator account.

13. The method as claimed in claim 1 further comprising the steps of:
tracking a current geospatial location for the user account with the corresponding user PC device;
relaying the current geospatial location from the corresponding user PC device, through the third-party server, and to the remote server; and
setting at least one of authentication condition of the approval template to a completed status with the remote server during step (F), if the current geospatial location is within a geofenced area defined by the approval template.
